(19) United States
(12) Patent Application Publication
(10) Pub. No.: US 2018/0082215 A1
(43) Pub. Date: Mar. 22, 2018

(54) INFORMATION PROCESSING APPARATUS AND INFORMATION PROCESSING METHOD

(71) Applicant: FUJITSU LIMITED, Kawasaki-shi (JP)

(72) Inventor: Yuji Mizobuchi, Kawasaki (JP)

(73) Assignee: FUJITSU LIMITED, Kawasaki-shi (JP)

(21) Appl. No.: 15/673,606

(22) Filed: Aug. 10, 2017

(30) Foreign Application Priority Data
Sep. 16, 2016 (JP) 2016-181414

(51) Int. Cl. G06N 99/00; G06N 3/08

(52) U.S. Cl. CPC G06N 99/005; G06N 3/08

(57) ABSTRACT

A control unit extracts a plurality of potential features each included in at least one of a plurality of teacher data elements, from the plurality of teacher data elements. The control unit calculates the degree of importance of each potential feature in machine learning on the basis of the frequency of occurrence of the potential feature in the teacher data elements. The control unit calculates the information amount of each teacher data element on the basis of the degrees of importance of the potential features included in the teacher data element. The control unit selects teacher data elements for use in the machine learning from the teacher data elements on the basis of the information amounts of the respective teacher data elements.

### CROSS-REFERENCE TO RELATED APPLICATION

This application is based upon and claims the benefit of priority of the prior Japanese Patent Application No. 2016-181414, filed on Sep. 16, 2016, the entire contents of which are incorporated herein by reference.

### FIELD

The embodiments discussed herein relate to an information processing apparatus and an information processing method.

### BACKGROUND

Data analysis using a computer may involve machine learning. The machine learning is divided into two main categories: supervised learning (learning with a teacher) and unsupervised learning (learning without a teacher). In the supervised learning, a computer creates a learning model by generalizing the relationship between factors (may be called explanatory variables or independent variables) and results (may be called response variables or dependent variables) on the basis of previously input data (may be called teacher data). The learning model is used to predict results for previously unknown cases. For example, it has been proposed to create a learning model for determining whether a plurality of documents are similar.

To create learning models, there are learning algorithms, such as Support Vector Machine (SVM) and neural networks.

Please see, for example, Japanese Laid-open Patent Publication Nos. 2003-16082, 2003-36262, 2005-181928, and 2010-204866.

By the way, it is preferable that machine learning create a learning model that has a high capability to predict results for previously unknown cases accurately. That is to say, high learning accuracy is preferable. However, conventionally, a plurality of teacher data elements used in the supervised learning may include some teacher data elements that prevent an improvement in the learning accuracy. For example, in the case of creating a learning model for determining whether a plurality of documents are similar, a plurality of documents that are used as teacher data elements may include documents that have no features useful for the determination or documents that have a little features useful for the determination. Use of such teacher data elements may prevent an improvement in the learning accuracy, which is a problem.

### SUMMARY

According to one aspect, there is provided an information processing apparatus including: a memory configured to store therein a plurality of teacher data elements; and a processor configured to perform a process including: extracting, from the plurality of teacher data elements, a plurality of potential features each included in at least one of the plurality of teacher data elements; calculating, based on a frequency of occurrence of each of the plurality of potential features in the plurality of teacher data elements, a degree of importance of said each potential feature in machine learning; calculating an information amount of each of the plurality of teacher data elements, using degrees of importance calculated respectively for a plurality of potential features included in said each teacher data element; and selecting a teacher data element for use in the machine learning from the plurality of teacher data elements, based on information amounts of respective ones of the plurality of teacher data elements.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an information processing apparatus according to a first embodiment;

FIG. 2 is a block diagram illustrating an example of hardware of an information processing apparatus;

FIG. 3 illustrates an example of a plurality of documents that are used as teacher data elements;

FIG. 4 illustrates an example of extracted potential features;

FIG. 5 illustrates an example of a result of counting the frequency of occurrence of each potential feature;

FIG. 6 illustrates an example of a result of calculating the degree of importance of each potential feature;

FIG. 7 illustrates an example of results of calculating potential information amounts;

FIG. 8 illustrates an example of a sorting result;

FIG. 9 illustrates an example of a plurality of generated teacher data sets;

FIG. 10 illustrates an example of the relationship between the number of documents included in a teacher data set and an F value;

FIG. 11 is a functional block diagram illustrating an example of functions of the information processing apparatus; and

FIG. 12 is a flowchart illustrating an example of information processing performed by the information processing apparatus according to a second embodiment.

### DESCRIPTION OF EMBODIMENTS

Several embodiments will be described below with reference to the accompanying drawings, wherein like reference numerals refer to like elements throughout.

### First Embodiment

A first embodiment will be described.

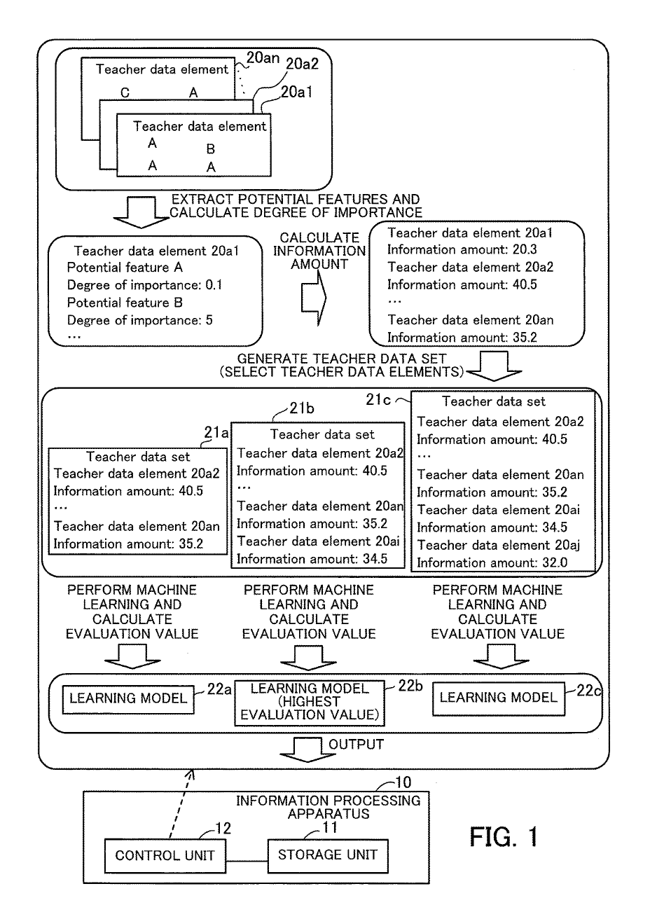

FIG. 1 illustrates an information processing apparatus according to the first embodiment.

The information processing apparatus 10 of the first embodiment selects teacher data that is used in supervised learning (learning with a teacher). The supervised learning is one type of machine learning. In the supervised learning, a learning model for predicting results for previously unknown cases is created based on previously input teacher data. The learning model is used to predict results for previously unknown cases. Results obtained by the machine learning may be used for various purposes, including not only for determining whether a plurality of documents are similar, but also for predicting the risk of a disease, predicting the demand of a future product or service, and predicting the yield of a new product in a factory. The information processing apparatus 10 may be a client computer or a server computer. The client computer is operated by a user, whereas the server computer is accessed from the client computer over a network.

In this connection, in the following, assume that the information processing apparatus 10 selects teacher data for use in the machine learning and performs the machine learning. Alternatively, an information processing apparatus different from the information processing apparatus 10 may be used to perform the machine learning.

The information processing apparatus 10 includes a storage unit 11 and a control unit 12. The storage unit 11 may be a volatile semiconductor memory, such as a Random Access Memory (RAM), or a non-volatile storage, such as a hard disk drive (HDD) or a flash memory. The control unit 12 is a processor, such as a Central Processing Unit (CPU) or a Digital Signal Processor (DSP), for example. In this connection, the control unit 12 may include an Application Specific Integrated Circuit (ASIC), Field Programmable Gate Array (FPGA), or other application-specific electronic circuits. The processor executes a program stored in a RAM or another memory (or the storage unit 11). For example, the program includes a program that causes the information processing apparatus 10 to perform machine learning on teacher data, which will be described later. A set of processors (multiprocessor) may be called a “processor”.

For the machine learning, machine learning algorithms, such as SVM, neural networks, and regression discrimination, are used.

The storage unit 11 stores therein a plurality of teacher data elements that are teacher data for the supervised learning. FIG. 1 illustrates n teacher data elements 20a1, 20a2, . . . , and 20an by way of example. Images, documents, and others may be used as the teacher data elements 20a1 to 20an.

The control unit 12 performs the following processing.

First, the control unit 12 reads the teacher data elements 20a1 to 20an from the storage unit 11, and extracts, from the teacher data elements 20a1 to 20an, a plurality of potential features each of which is included in at least one of the teacher data elements 20a1 to 20an.

FIG. 1 illustrates an example where potential features A, B, and C are included in the teacher data elements 20a1 to 20an. What are extracted as the potential features A to C from the teacher data elements 20a1 to 20an is determined according to what is learned in the machine learning. For example, in the case of creating a learning model for determining whether two documents are similar, the control unit 12 takes words and sequences of words as features to be extracted. In the case of creating a learning model for determining whether two images are similar, the control unit 12 takes pixel values and sequences of pixel values as features to be extracted.

Then, the control unit 12 calculates the degree of importance of each potential feature A to C in the machine learning, on the basis of the frequency of occurrence of the potential feature A to C in the teacher data elements 20a1 to 20an. For example, a potential feature has a higher degree of importance as its frequency of occurrence in all the teacher data elements 20a1 to 20an is lower. In this connection, if the frequency of occurrence of a potential feature is too low, the control unit 12 may take the potential feature as a noise and determine its degree of importance to be zero.

FIG. 1 illustrates an example of the degrees of importance of the potential features A and B included in the teacher data element 20a1. Referring to the example of FIG. 1, the potential feature A has the degree of importance of 0.1, and the potential feature B has the degree of importance of 5. This means that the potential feature B has a lower frequency of occurrence than the potential feature A in all the teacher data elements 20a1 to 20an.

For example, in the case where the potential features A to C are words or sequences of words, an inverse document frequency (idf) or another may be used as the degree of importance. Even if a potential feature is not useful for sorting-out, its frequency of occurrence becomes lower as the potential feature consists of more words. Therefore, the control unit 12 may normalize the idf value by dividing by the length of the potential feature (the number of words) and use the resultant as the degree of importance. The normalization by dividing the idf value by the number of words prevents obtaining a high degree of importance for a potential feature that just consists of many words and is not useful for sorting-out.

Further, the control unit 12 calculates the information amount (hereinafter, may be referred to as potential information amount) of each of the teacher data elements 20a1 to 20an, using the degrees of importance calculated for the potential features included in the teacher data element 20a1 to 20an.

For example, the information amount of each teacher data element 20a1 to 20an is a sum of the degrees of importance calculated for the potential features included in the teacher data element 20a1 to 20an.

Referring to the example of FIG. 1, the information amount of the teacher data element 20a1 is calculated as 20.3, the information amount of the teacher data element 20a2 is calculated as 40.5, and the information amount of the teacher data element 20an is calculated as 35.2.

Then, the control unit 12 selects teacher data elements for use in the machine learning, from the teacher data elements 20a1 to 20an on the basis of the information amounts of the respective teacher data elements 20a1 to 20an.

For example, the control unit 12 generates a teacher data set including teacher data elements in descending order from the largest information amount down to the k-th largest information amount (k is a natural number of two or greater) among the teacher data elements 20a1 to 20an. Alternatively, the control unit 12 may select teacher data elements with information amounts larger than or equal to a threshold, from the teacher data elements 20a1 to 20an, to thereby generate a teacher data set. Then, the control unit 12 generates a plurality of teacher data sets by sequentially adding a teacher data element to the teacher data set in descending order of information amount.

For example, the teacher data set 21a of FIG. includes teacher data elements from the teacher data elements 20a2 with the largest information amount to the teacher data element 20an with the k-th largest information amount. The teacher data set 21b generated next additionally includes the teacher data element 20ai with the (k+1)th largest information amount (34.5). The teacher data set 21c generated next additionally includes the teacher data element 20aj with the (k+2)th largest information amount (32.0).

For example, “k” is the minimum number of teacher data elements to be used for calculating the evaluation value of a learning model, which will be described later. In the case where the control unit 12 uses the 10-fold cross validation to calculate the evaluation value, “k” is set to 10.

Then, the control unit 12 creates a plurality of learning models by performing the machine learning on the individual teacher data sets.

For example, the control unit 12 creates a learning model 22a for determining whether two documents are similar, by performing the machine learning on the teacher data set 21a. In this case, the teacher data elements 20a2 to 20an included in the teacher data set 21a are documents, and each teacher data element 20a2 to 20an is given identification information indicating whether the teacher data element 20a2 to 20an belongs to a similarity group. For example, in the case where the teacher data elements 20a2 and 20an are similar, both of these teacher data elements 20a2 and 20an are given identification information indicating that they belong to a similarity group.

In addition, the control unit 12 creates learning models 22b and 22c on the basis of the teacher data sets 21b and 21c in the same way.

Then, the control unit 12 calculates an evaluation value regarding the performance of each of the learning models 22a, 22b, and 22c created by the machine learning.

For example, to calculate an evaluation value with the 10-fold cross validation using ten teacher data elements 20a2 to 20an included in the teacher data set 21a, the control unit 12 performs the following processing.

In the machine learning, the control unit 12 divides the teacher data elements 20a2 to 20an included in the teacher data set 21a into nine teacher data elements and one teacher data element. The nine teacher data elements are used as training data for creating the learning model 22a. The one teacher data element is used as test data for evaluating the learning model 22a. The control unit 12 repeatedly evaluates the learning model 22a ten times, each time using a different teacher data element among the ten teacher data elements 20a2 to 20an as test data. Then, the control unit 12 calculates the evaluation value on the basis of the results of performing the evaluation ten times.

For example, an F value is used as the evaluation value. The F value is a harmonic mean of recall and precision.

An evaluation value is calculated for each of the learning models 22b and 22c in the same way, and is stored in the storage unit 11, for example.

The control unit 12 retrieves the evaluation values as the results of the machine learning from the storage unit 11, for example, and searches for a subset of the teacher data elements 20a1 to 20an, which produces a result of the machine learning satisfying a prescribed condition. For example, the control unit 12 searches for a teacher data set that produces a learning model with the highest evaluation value. If the machine learning is performed by an information processing apparatus different from the information processing apparatus 10, the control unit 12 obtains the evaluation values calculated by the information processing apparatus and then performs the above processing.

After that, the control unit 12 outputs the learning model with the highest evaluation value. Alternatively, the control unit 12 may output a teacher data set that produces the learning model with the highest evaluation value.

FIG. 1 illustrates an example where the learning model 22b has the highest evaluation value among the learning models 22a, 22b, and 22c. In this case, the control unit 12 outputs the learning model 22b.

For example, in the case where the learning model 22b is a neural network, weight values (called coupling coefficients) for couplings between nodes (neurons) of the neural network obtained by the machine learning, or others are output. The learning model 22b output by the control unit 12 may be stored in the storage unit 11 or may be output to an external apparatus other than the information processing apparatus 10.

By entering new and unknown data (documents, images, or the like) into the learning model 22b, a result of whether the data belongs to a similarity group, or another result is obtained.

As described above, the information processing apparatus 10 of the first embodiment calculates the degree of importance of each potential feature on the basis of the frequency of occurrence in a plurality of teacher data elements, calculates the information amount of each teacher data element using the calculated degrees of importance, and selects teacher data elements for use in the machine learning. This makes it possible to exclude inappropriate teacher data elements with little features (small information amount), and thus to improve the learning accuracy.

Further, the information processing apparatus of the first embodiment outputs a learning model created by the machine learning using teacher data elements with large information amounts. Referring to the example of FIG. 1, the learning model 22c that is created based on the teacher data set 21c including the teacher data element 20aj with a smaller information amount than the teacher data element 20ai is not output. In the machine learning, an improvement in the learning accuracy is not expected if teacher data elements with small information amounts are used. For example, teacher data elements that include many words and many sequences of words appearing in all documents are not useful for accurately determining the similarity of two documents.

Since the information processing apparatus 10 of the first embodiment excludes teacher data elements with small information amounts, it is possible to obtain a learning model that achieves a high accuracy.

In this connection, the control unit 12 may be designed to perform the machine learning and calculate an evaluation value each time one teacher data set is generated. In the case where teacher data sets are generated by sequentially adding a teacher data element in descending order, it is considered that the evaluation value increases first, but at some point, starts to decrease due to teacher data elements that do not contribute to an improvement in the machine learning accuracy. The control unit 12 may stop the generation of the teacher data sets and the machine learning when the evaluation value starts to decrease. This shortens the time for learning.

### Second Embodiment

A second embodiment will now be described.

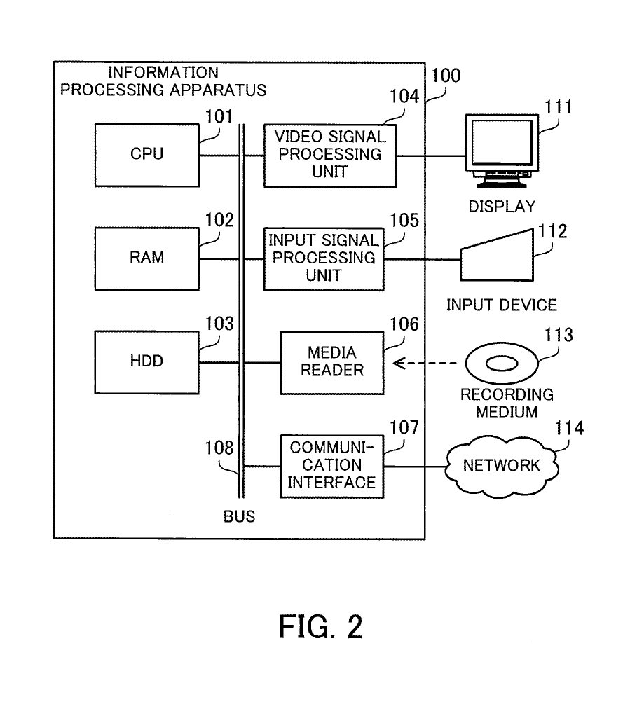

FIG. 2 is a block diagram illustrating an example of hardware of an information processing apparatus.

The information processing apparatus 100 includes a CPU 101, a RAM 102, an HDD 103, a video signal processing unit 104, an input signal processing unit 105, a media reader 106, and a communication interface 107. The CPU 101, RAM 102, HDD 103, video signal processing unit 104, input signal processing unit 105, media reader 106, and communication interface 107 are connected to a bus 108. In this connection, the information processing apparatus 100 corresponds to the information processing apparatus 10 of the first embodiment, the CPU 101 corresponds to the control unit 12 of the first embodiment, and the RAM 102 or HDD 103 corresponds to the storage unit 11 of the first embodiment.

The CPU 101 is a processor including an operating circuit for executing instructions of programs. The CPU 101 loads at least part of a program and data from the HDD 103 to the RAM 102 and then executes the program. In this connection, the CPU 101 may be provided with a plurality of processor cores, and the information processing apparatus 100 may be provided with a plurality of processors. Processing that will be described later may be performed in parallel using the plurality of processors or processor cores. In addition, a set of processors (multiprocessor) may be called a “processor”.

The RAM 102 is a volatile semiconductor memory for temporarily storing programs to be executed by the CPU 101 and data to be used by the CPU 101 in processing. In this connection, the information processing apparatus 100 may be provided with memories of kinds other than RAMS or a plurality of memories.

The HDD 103 is a non-volatile storage device for storing software programs, such as Operating System (OS), middleware, and application software, and data. For example, the programs include a program that causes the information processing apparatus 100 to perform machine learning. In this connection, the information processing apparatus 100 may be provided with other kinds of storage devices, such as a flash memory and Solid State Drive (SSD), or a plurality of non-volatile storage devices.

The video signal processing unit 104 outputs images to a display 111 connected to the information processing apparatus 100 in accordance with instructions from the CPU 101. As the display 111, a Cathode Ray Tube (CRT) display, a Liquid Crystal Display (LCD), Plasma Display Panel (PDP), Organic Electro-Luminescence (OEL) display or another may be used.

The input signal processing unit 105 receives an input signal from an input device 112 connected to the information processing apparatus 100, and gives the received input signal to the CPU 101. As the input device 112, a pointing device, such as a mouse, a touch panel, a touchpad, or a trackball, a keyboard, a remote controller, a button switch, or another may be used. In addition, plural kinds of input devices may be connected to the information processing apparatus 100.

The media reader 106 is a device for reading programs and data from a recording medium 113. As the recording medium 113, a magnetic disk, an optical disc, a Magneto-Optical disk (MO), a semiconductor memory, or another may be used. Magnetic disks include Flexible Disks (FD) and HDDs. Optical Discs include Compact Discs (CD) and Digital Versatile Discs (DVD).

The media reader 106 copies programs and data read from the recording medium 113, to another recording medium, such as the RAM 102 or HDD 103. The read program is executed by the CPU 101, for example. In this connection, the recording medium 113 may be a portable recording medium, which may be used for distribution of the programs and data. In addition, the recording medium 113 and HDD 103 may be called computer-readable recording media.

The communication interface 107 is connected to a network 114 for performing communication with another information processing apparatus over the network 114. The communication interface 107 may be a wired communication interface or a wireless communication interface. The wired communication interface is connected to a switch or another communication apparatus with a cable, whereas the wireless communication interface is connected to a base station with a wireless link.

In the machine learning of the second embodiment, the information processing apparatus 100 previously collects data including a plurality of teacher data elements indicating already known cases. The information processing apparatus 100 or another information processing apparatus may collect the data over the network 114 from various devices, such as a sensor device. The collected data may be a large size of data, which is called “big data”.

The following describes an example in which a learning model for sorting out similar documents is created using documents at least partly written in natural language as teacher data elements.

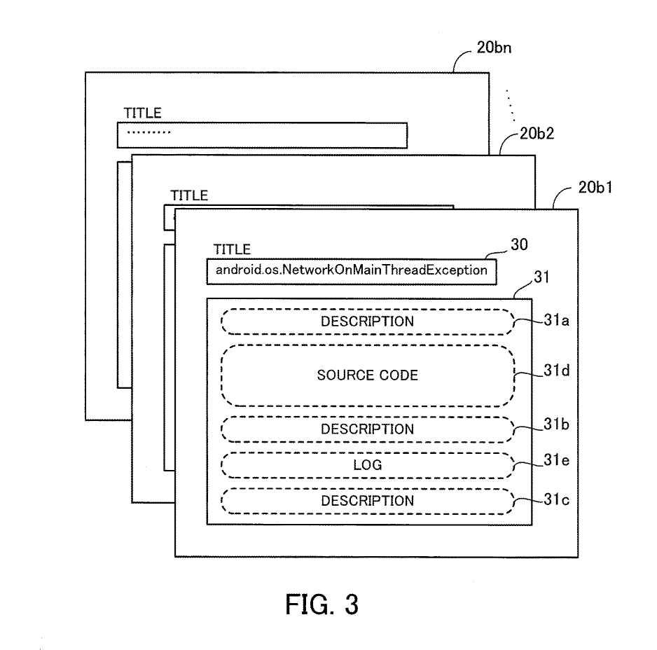

FIG. 3 illustrates an example of a plurality of documents that are used as teacher data elements.

FIG. 3 illustrates, by way of example, documents 20b1, 20b2, . . . , 20bn that are collected from an online community for programmers to share their knowledge (for example, stack overflow). For example, the documents 20b1 to 20bn are reports on bugs.

The document 20b1 includes a title 30 and a body 31 that includes, for example, descriptions 31a, 31b, and 31c, a source code 31d, and a log 31e. The documents 20b2 to 20bn have the same format.

In this connection, each of the document 20b1 to 20bn is tagged with identification information indicating whether the document 20b1 to 20bn belongs to a similarity group. A plurality of documents regarded as being similar are tagged with identification information indicating that they belong to a similarity group. The information processing apparatus 100 collects such identification information as well.

The information processing apparatus 100 extracts a plurality of potential features from the documents 20b1 to 20bn. For example, the information processing apparatus 100 extracts a plurality of potential features from the title 30 and descriptions 31a, 31b, and 31c of the document 20b1 with natural language processing. The plurality of potential features are words or sequences of words. For example, the information processing apparatus 100 extracts words and sequences of words as potential features from each sentence. Delimiters between words are recognized from spaces. Dots and underscores are ignored. The minimum unit for potential features is a single word. In addition, the maximum length for potential features included in a sentence may be the number of words included in the sentence or may be determined in advance.

In this connection, the same word or the same sequence of words tends to be used too many times in the source code 31d and log 31e, and therefore it is preferable that the source code 31d and log 31e not be searched to extract potential features, unlike the title and the descriptions 31a, 31b, and 31c. Therefore, the information processing apparatus 100 does not extract potential features from the source code 31d or log 31e.

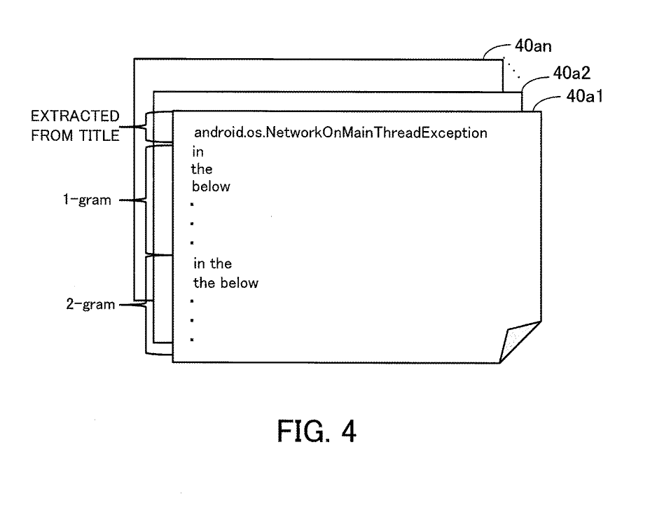

FIG. 4 illustrates an example of extracted potential features.

Potential feature groups 40a1, 40a2, . . . , 40an include potential features extracted from documents 20b1 to 20bn. For example, the potential feature group 40a1 includes words and sequences of words which are potential features extracted from the document 20b1. The first line of the potential feature group 40a1 indicates a potential feature (extracted as a single word because dots are ignored) extracted from the title 30. The second and subsequent lines indicate N-gram (N=1, 2, potential features extracted from the body 31. In the machine learning of the second embodiment, the term N-gram denotes a sequence of N words (a single word in the case of N=1).

Then, the information processing apparatus 100 counts the frequency of occurrence of each potential feature in all the documents 20b1 to 20bn. It is assumed that the frequency of occurrence of a potential feature indicates how many among the documents 20b1 to 20bn include the potential feature. For simple explanation, it is assumed that the number (n) of documents 20b1 to 20bn is 100.

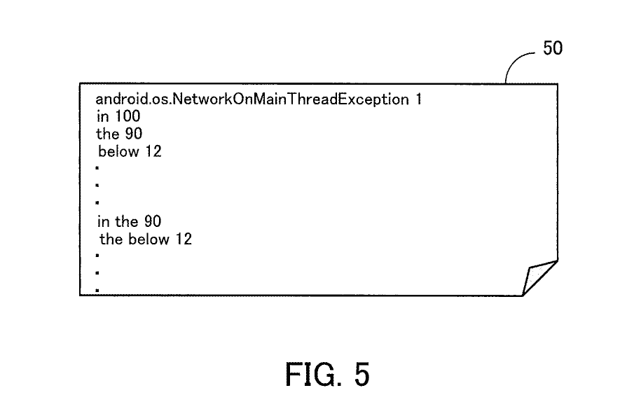

FIG. 5 illustrates an example of a result of counting the frequency of occurrence of each potential feature.

As indicated in the counting result 50 of the frequency of occurrence illustrated in FIG. 5, the frequency of occurrence of a potential feature that is the title 30 of the document 20b1 is one. With respect to 1-gram potential features, the frequency of occurrence of “in” is 100, the frequency of occurrence of “the” is 90, and the frequency of occurrence of “below” is 12. In addition, with respect to 2-gram potential features, the frequency of occurrence of “in the” is 90, and the frequency of occurrence of “the below” is 12.

Then, the information processing apparatus 100 calculates the degree of importance of each potential feature in the machine learning, on the basis of the frequency of occurrence of the potential feature in all the documents 20b1 to 20bn.

For example, as the degree of importance, an idf value or a mutual information amount may be used.

Here, idf(t) that is an idf value for a word or a sequence of words is calculated by the following equation (1):

$$idf ( t ) = log \frac{n}{df ( t )} \qquad ( 1 )$$

where “n” denotes the number of all documents, and “df(t)” denotes the number of documents including the word or the sequence of words.

The mutual information amount represents a measurement of interdependence between two random variables. Considering, as two random variables, a random variable X indicating a probability of occurrence of a word or a sequence of words in all documents and a random variable Y indicating a probability of occurrence of a document belonging to a similarity group in all the documents, the mutual information amount I(X; Y) is calculated by the following equation (2), for example:

$$I ( X ; Y ) = {\sum }_{y ∈ Y} {\sum }_{x ∈ X} p ( x , y ) {log}_{2} \frac{p ( x , y ) }{p ( x ) p ( y )} \qquad ( 2 )$$

In the equation (2), p(x,y) is a joint distribution function of X and Y, p(x) and p(y) are marginal probability distribution functions of X and Y, respectively. Each of x and y takes a value of zero or one. “x=1” indicates that a word or a sequence of words occurs in a document. “x=0” indicates that a word or a sequence of words does not occur in a document. “y=1” indicates that a document belongs to a similarity group, and “y=0” indicates that a document does not belong to a similarity group.

For example, taking the number of documents where a potential feature t1, which is a word or a sequence of words, occurs as Mt1, and the number of all documents as n, p(x=1) is calculated as Mt1/n. Taking the number of documents where the potential feature t1 does not occur as Mt2, p(x=0) is calculated as Mt2/n. Further, taking the number of documents belonging to a similarity group g1 as Mg1, p(y=1) is calculated as Mg1/n. Taking the number of documents that do not belong to the similarity group g1 as Mg0, p(y=0) is calculated as Mg0/n. Still further, if the potential feature t1 occurs and the number of documents belonging to the similarity group g1 is taken as M11, p(1, 1) is calculated as M11/n. If the potential feature t1 does not occur and the number of documents belonging to the similarity group g1 is taken as M01, p(0, 1) is calculated as M01/n. If the potential feature t1 occurs and the number of documents that do not belong to the similarity group g1 is taken as M10, p(1, 0) is calculated as M10/n. If the potential feature t1 does not occur and the number of documents that do not belong to the similarity group g1 is taken as M00, p(0, 0) is calculated as M00/n. It is considered that, as the potential feature t1 has a larger mutual information amount I(X; Y), the potential feature t1 is more likely to represent the features of the similarity group g1.

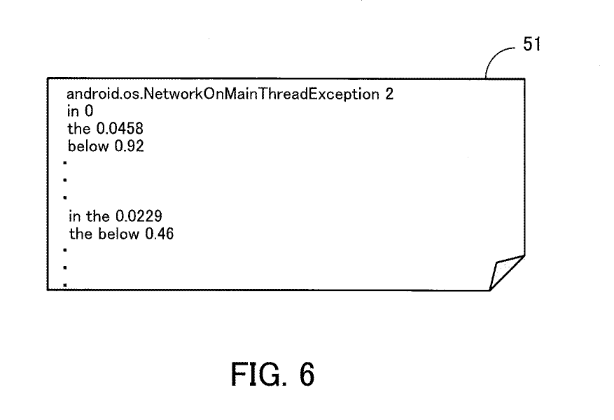

FIG. 6 illustrates an example of a result of calculating the degree of importance of each potential feature.

The calculation result 51 of the degree of importance, illustrated in FIG. 6, indicates an example of the degree of importance based on an idf value for each potential feature, which is a word or a sequence of words. Referring to the example of FIG. 6, in the equation (1), the idf value of each potential feature is normalized by dividing by the number of words, taking “n” as 100 and the base of log as 10, and the resultant value is used as the degree of importance.

For example, as described earlier with reference to FIG. 5, the frequency of occurrence of a potential feature “below” is 12, and therefore the idf value is calculated as 0.92 from the equation (1). The number of words in the potential feature “below” is one, and therefore, the degree of importance is calculated as 0.92, as illustrated in FIG. 6. In addition, as described earlier with reference to FIG. 5, the frequency of occurrence of a potential feature “the below” is 12, and therefore the idf value is calculated as 0.92 from the equation (1). The number of words in the potential feature “the below” is two, and therefore, the degree of importance is calculated as 0.46 as illustrated in FIG. 6.

Even a potential feature that is not useful for sorting-out tends to have a smaller frequency of occurrence, because the potential feature consists of more words. To deal with this, the information processing apparatus 100 normalizes the idf value of each potential feature by dividing by the number of words in the potential feature, so as to prevent a high degree of importance for a potential feature that merely consists of a large number of words and is not useful for sorting-out.

Then, with respect to each of the documents 20b1 to 20bn, the information processing apparatus 100 adds up the degrees of importance of one or a plurality of potential features included in the document 20b1 to 20bn to calculate a potential information amount. The potential information amount is the sum of the degrees of importance.

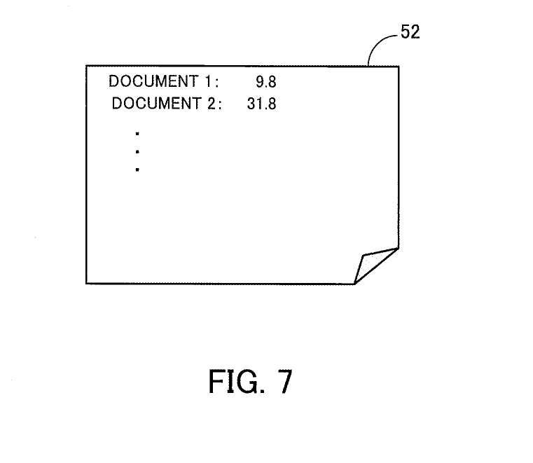

FIG. 7 illustrates an example of results of calculating potential information amounts.

For example, in the calculation result 52 of the potential information amounts, “document 1: 9.8” indicates that the potential information amount of the document 20b1 is 9.8. In addition, “document 2: 31.8” indicates that the potential information amount of the document 20b2 is 31.8.

After that, the information processing apparatus 100 sorts the documents 20b1 to 20bn in descending order of potential information amount.

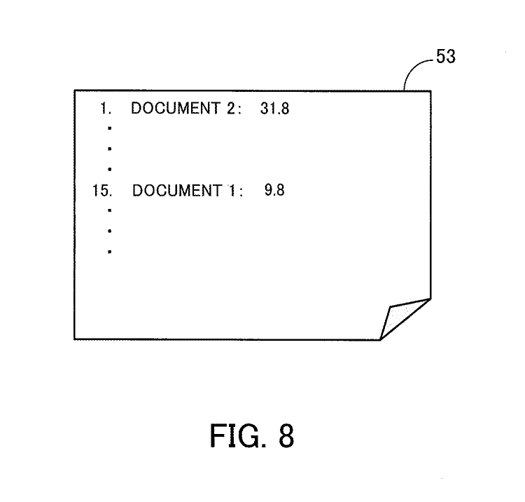

FIG. 8 illustrates an example of a sorting result.

In the sorting result 53, the documents 20b1 to 20bn represented by “document 1”, “document 2”, and the like are arranged in order from “document 2” (document 20b2) that has the largest potential information amount.

Then, the information processing apparatus 100 generates a plurality of teacher data sets on the basis of the sorting result 53.

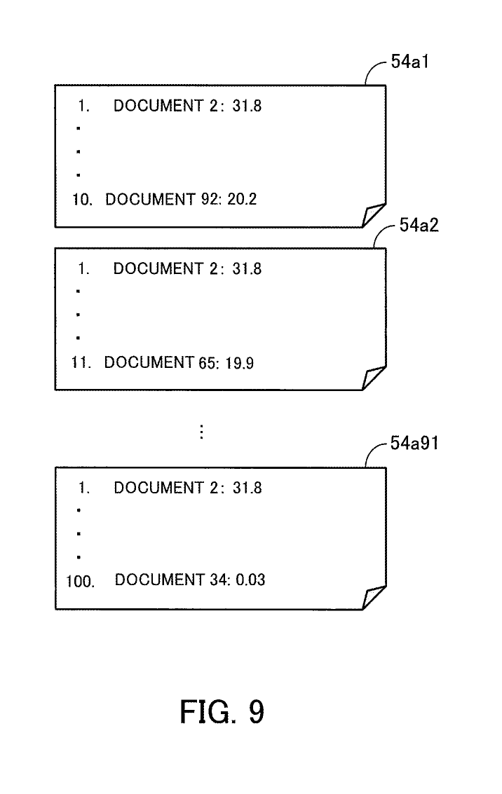

FIG. 9 illustrates an example of a plurality of generated teacher data sets.

FIG. 9 illustrates, by way of example, 91 teacher data sets 54a1, 54a2, . . . , 54a91 each of which is used by the information processing apparatus 100 to calculate the evaluation value of a learning model with the 10-fold cross validation.

In the teacher data set 54a1, 10 documents are listed in descending order of potential information amount. In the teacher data set 54a1, the “document 2” with the largest potential information amount is the first in the list, and the “document 92” with the tenth largest potential information amount is the last in the list. In the teacher data set 54a2 generated next, the “document 65” with the eleventh largest potential information amount is additionally listed. At the end of the teacher data set 54a91 generated last, the “document 34” with the smallest potential information amount is additionally listed.

Then, the information processing apparatus 100 performs the machine learning on each of the above-described teacher data sets 54a1 to 54a91, for example.

First, the information processing apparatus 100 divides the teacher data set 54a1 into ten divided elements, and performs the machine learning using nine of the ten divided elements as training data to create a learning model for determining whether two documents are similar. For the machine learning, a machine learning algorithm, such as SVM, neural networks, or regression discrimination, is used, for example.

Then, the information processing apparatus 100 evaluates the learning model using one of the ten divided elements as test data. For example, the information processing apparatus 100 performs a prediction process using the learning model to determine whether a document included in the one divided element used as the test data belongs to a similarity group.

The information processing apparatus 100 repeatedly performs the same process ten times, each time using a different one of the ten divided elements as test data. Then, the information processing apparatus 100 calculates an evaluation value. As the evaluation value, an F value may be used, for example. The F value is a harmonic mean of recall and precision, and is calculated by the equation (3):

$$F = \frac{2 PR}{P + R} \qquad ( 3 )$$

where P denotes recall and R denotes precision.

The recall is a ratio of documents determined correctly to belong to a similarity group in the evaluation of the learning model to all documents belonging to the similarity group. The precision is a ratio of how many times a document is determined correctly to belong to a similarity group or not to belong to a similarity group to the total number of times the determination is performed.

For example, assuming that seven documents belong to a similarity group in the teacher data set 54a1 and three documents are determined correctly to belong to the similarity group in the evaluation of the learning model, the recall P is calculated as 3/7. In addition, assuming that out of the ten determinations made in the 10-fold cross validation, an accurate determination result is obtained six times, the precision R is calculated as 0.6.

The same process is performed on the teacher data sets 54a2 to 54a91. In this connection, eleven or more documents are included in each of the teacher data set 54a2 to 54a91, and this means that two or more documents are included in at least one of the ten divided elements in the 10-fold cross validation.

Then, the information processing apparatus 100 outputs a learning model with the highest evaluation value.

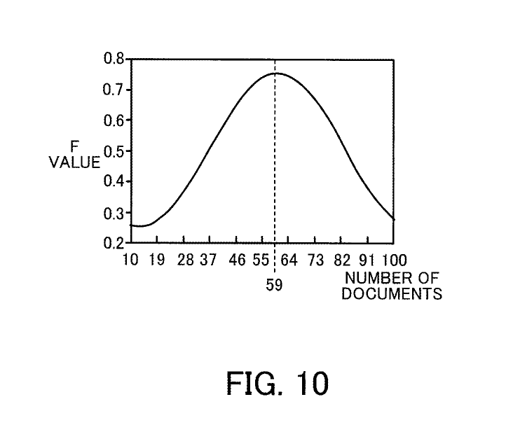

FIG. 10 illustrates an example of the relationship between the number of documents included in a teacher data set and an F value.

In FIG. 10, the horizontal axis represents the number of documents and the vertical axis represents an F value. In the example of FIG. 10, the highest F value is obtained when the number of documents is 59. Therefore, the information processing apparatus 100 outputs the learning model created based on a teacher data set composed of 59 documents. For example, for a single teacher data set in the 10-fold cross validation, a process of creating a learning model using nine divided elements of the teacher data set as training data and evaluating the learning model using one divided element as test data is repeatedly performed ten times. That is to say, each of the ten learning models is evaluated, and one or a plurality of learning models that produce accurate values are output.

For example, in the case where a learning model is a neural network, coupling coefficients between nodes (neurons) of the neural network obtained by the machine learning, and others are output. In the case where a learning model is obtained by SVM, coefficients included in the learning model, and others are output. The information processing apparatus 100 sends the learning model to another information processing apparatus connected to the network 114, via the communication interface 107, for example. In addition, the information processing apparatus 100 may store the learning model in the HDD 103.

The information processing apparatus 100 that performs the above processing is represented by the following functional block diagram, for example.

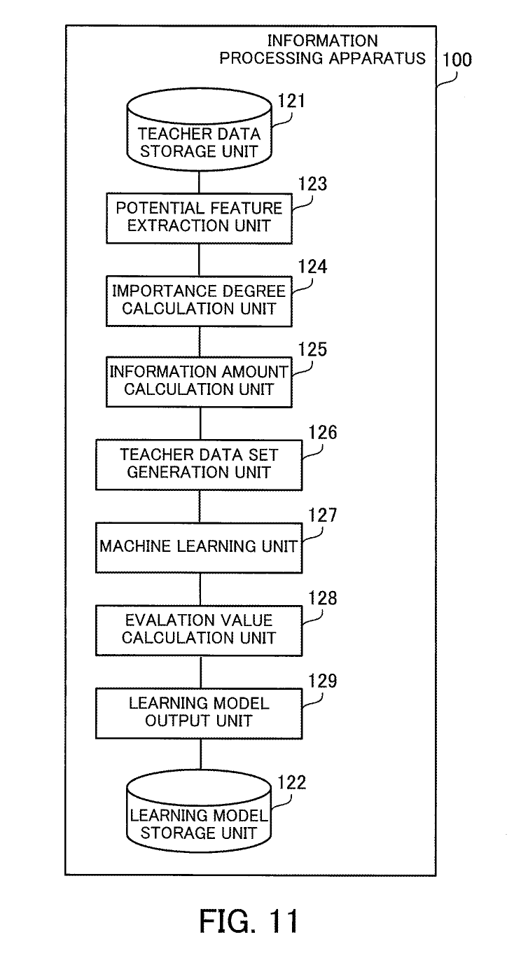

FIG. 11 is a functional block diagram illustrating an example of functions of the information processing apparatus.

The information processing apparatus 100 includes a teacher data storage unit 121, a learning model storage unit 122, a potential feature extraction unit 123, an importance degree calculation unit 124, an information amount calculation unit 125, a teacher data set generation unit 126, a machine learning unit 127, an evaluation value calculation unit 128, and a learning model output unit 129. The teacher data storage unit 121 and the learning model storage unit 122 may be implemented by using a storage space set aside in the RAM 102 or HDD 103, for example. The potential feature extraction unit 123, importance degree calculation unit 124, information amount calculation unit 125, teacher data set generation unit 126, machine learning unit 127, evaluation value calculation unit 128, and learning model output unit 129 may be implemented by using program modules executed by the CPU 101, for example.

The teacher data storage unit 121 stores therein a plurality of teacher data elements, which are teacher data to be used in the supervised machine learning. Images, documents, and others may be used as the plurality of teacher data elements. Data stored in the teacher data storage unit 121 may be collected by the information processing apparatus 100 or another information processing apparatus from various devices. Alternatively, such data may be entered into the information processing apparatus 100 or the other information processing apparatus by a user.

The learning model storage unit 122 stores therein a learning model (a learning model with the highest evaluation value) output from the learning model output unit 129.

The potential feature extraction unit 123 extracts a plurality of potential features from a plurality of teacher data elements stored in the teacher data storage unit 121. If the teacher data elements are documents, for example, potential features are words or sequences of words, as illustrated in FIG. 4.

The importance degree calculation unit 124 calculates, for each of the plurality of potential features, the degree of importance on the basis of the frequency of occurrence of the potential feature in all teacher data elements. As described earlier, the degree of importance is calculated based on an idf value or mutual information amount, for example. As the degree of importance, a value obtained by normalizing the idf value with the length (the number of words) of the potential feature may be used, as illustrated in FIG. 5, for example.

The information amount calculation unit 125 adds up the degrees of importance of one or a plurality of potential features included in each of the plurality of teacher data elements, to thereby calculate a potential information amount. The potential information amount is the sum of the degrees of importance calculated in connection to the teacher data element. In the case where the teacher data elements are documents, for example, the calculation result 52 of the potential information amount is obtained, as illustrated in FIG. 7.

The teacher data set generation unit 126 sorts the teacher data elements in the descending order of potential information amount. Then, the teacher data set generation unit 126 generates a plurality of teacher data sets by sequentially adding teacher data elements one by one in descending order of potential information amount. In the case where the teacher data elements are documents, for example, the teacher data sets 54a1 to 54a91 are obtained, as illustrated in FIG. 9.

The machine learning unit 127 performs the machine learning on each of the plurality of teacher data sets. For example, the machine learning unit 127 creates a learning model for determining whether two documents are similar, by performing the machine learning on each teacher data set.

The evaluation value calculation unit 128 calculates an evaluation value for the performance of the learning model created by the machine learning. The evaluation value calculation unit 128 calculates an F value as the evaluation value, for example.

The learning model output unit 129 outputs a learning model with the highest evaluation value. For example, in the example of FIG. 10, the evaluation value (F value) of the learning model created based on the teacher data set whose number of documents is 59 is the highest, so that this learning model is output. The learning model output by the learning model output unit 129 may be stored in the learning model storage unit 122 or output to the outside of the information processing apparatus 100.

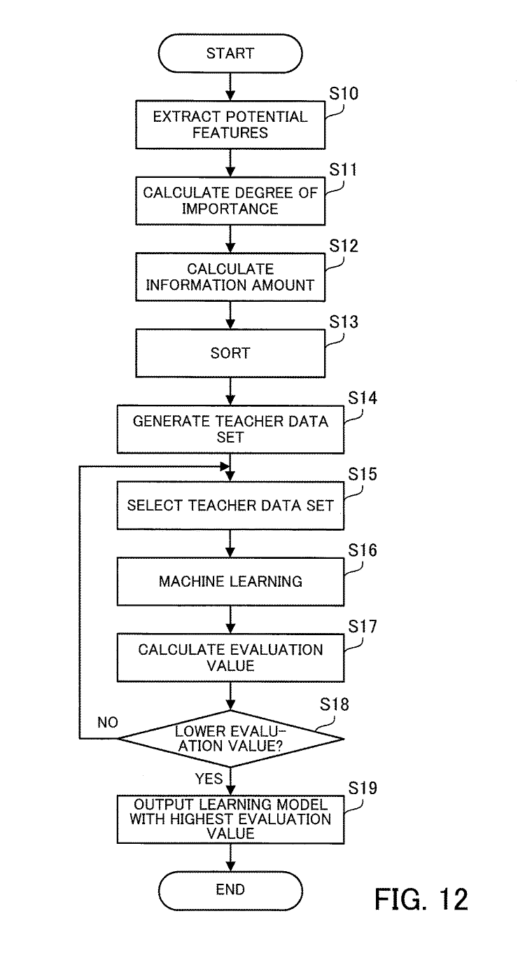

FIG. 12 is a flowchart illustrating an example of information processing performed by the information processing apparatus according to the second embodiment.

(S10) The potential feature extraction unit 123 extracts a plurality of potential features from a plurality of teacher data elements stored in the teacher data storage unit 121.

(S11) The importance degree calculation unit 124 calculates, for each of the plurality of potential features extracted at step S10, the degree of importance in the machine learning on the basis of the frequency of occurrence of the potential feature in all the teacher data elements.

(S12) The information amount calculation unit 125 adds up the degrees of importance of one or a plurality of potential features included in each of the plurality of teacher data elements, calculated at step S11, to thereby calculate a potential information amount. The potential information amount is the sum of the degrees of importance calculated in connection to the teacher data element.

(S13) The teacher data set generation unit 126 sorts the teacher data elements in descending order of potential information amount calculated at step S12.

(S14) The teacher data set generation unit 126 generates a plurality of teacher data sets by sequentially adding the teacher data elements sorted at step S13, one by one in descending order of potential information amount. In the case of performing the 10-fold cross validation for calculating evaluation values, the initial number of teacher data elements included in a teacher data set is ten or more.

(S15) The machine learning unit 127 selects the teacher data sets one by one in ascending order of the number of teacher data elements from the plurality of teacher data sets, for example.

(S16) The machine learning unit 127 performs the machine learning on the selected teacher data set to thereby create a learning model.

(S17) The evaluation value calculation unit 128 calculates an evaluation value for the performance of the learning model created by the machine learning. For example, the evaluation value calculation unit 128 calculates an F value as the evaluation value.

(S18) The learning model output unit 129 determines whether the evaluation value for the learning model created based on the teacher data set currently selected is lower than that for the learning model created based on the teacher data set selected last time. If the current evaluation value is not lower, step S15 and subsequent steps are repeated. If the current evaluation value is lower, the process proceeds to step S19.

(S19) Since the current evaluation value is lower (a learning model that produces a lower evaluation value is detected), the learning model output unit 129 outputs the learning model created based on the teacher data set selected last time, as a learning model with the highest evaluation value, and then completes the process (machine learning process). For example, by entering new and unknown data (documents, images, or the like) into the output learning model, a result indicating whether the data belongs to a similarity group is obtained.

In the process illustrated in FIG. 12, it is expected that, once a lower evaluation value is obtained while the evaluation values are successively calculated for the learning models created based on the teacher data sets selected in ascending order of the number of teacher data elements, the evaluation values obtained thereafter get lower and lower.

In this connection, it may be designed so that, at step S14, the teacher data set generation unit 126 does not generate all teacher data sets 54a1 to 54a91, illustrated in FIG. 9, at a time. For example, the teacher data set generation unit 126 generates the teacher data sets 54a1 to 54a91 one by one, and steps S16 to S18 may be executed each time one teacher data set is generated. In this case, when an evaluation value lower than a previous one is obtained, the teacher data set generation unit 126 stops further generation of a teacher data set.

In addition, in the case where the machine learning is performed plural times, the information processing apparatus 100 may refer to the potential information amounts of a document group included in the teacher data set previously used for creating a learning model with the highest evaluation value, which is output in the previous machine learning. In this case, the information processing apparatus 100 may create and evaluate a learning model using a teacher data set including a document group with the same potential information amounts as the document group included in the previously used teacher data set, in order to detect a learning model with the highest evaluation value. This approach reduces the time for learning.

Further, steps S16 and 17 may be executed by an external information processing apparatus different from the information processing apparatus 100. In this case, the information processing apparatus 100 obtains evaluation values from the external information processing apparatus and then executes step S18.

With the information processing apparatus of the second embodiment, it is possible to perform the machine learning on a teacher data set in which teacher data elements with larger potential information amounts are preferentially selected. This makes it possible to exclude inappropriate teacher data elements with little features (with small potential information amounts), which improves the learning accuracy.

Still further, the information processing apparatus 100 outputs a learning model created by performing the machine learning on a teacher data set in which teacher data elements with large potential information amounts are preferentially collected. For example, referring to the example of FIG. 10, the information processing apparatus 100 does not output the learning models created based on the teacher data sets (the number of documents is 60 to 100) including documents with smaller potential information amounts than each document of the teacher data set including 59 documents. Since the information processing apparatus 100 excludes teacher data elements (documents) with small potential information amounts, it is possible to obtain a learning model that achieves a high accuracy.

In addition, as illustrated in FIG. 12, when an evaluation value lower than a previous one is obtained, the information processing apparatus 100 stops the machine learning, thereby reducing the time for learning.

In this connection, as described earlier, the information processing of the first embodiment is implemented by causing the information processing apparatus 10 to execute an intended program. The information processing of the second embodiment is implemented by causing the information processing apparatus 100 to execute an intended program.

Such a program may be recorded on a computer-readable recording medium (for example, the recording medium 113). As the recording medium, a magnetic disk, an optical disc, a magneto-optical disk, a semiconductor memory, or another may be used, for example. Magnetic disks include FDs and HDDs. Optical discs include CDs, CD-Rs (Recordable), CD-RWs (Rewritable), DVDs, DVD-Rs, and DVD-RWs. The program may be recorded in portable recording media, which are then distributed. In this case, the program may be copied from a portable recording medium to another recording medium (for example, HDD 103), and then be executed.

According to one aspect, it is possible to improve the learning accuracy of machine learning.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus comprising:
a memory configured to store therein a plurality of teacher data elements; and
a processor configured to perform a process including:
extracting, from the plurality of teacher data elements, a plurality of potential features each included in at least one of the plurality of teacher data elements;
calculating, based on a frequency of occurrence of each of the plurality of potential features in the plurality of teacher data elements, a degree of importance of said each potential feature in machine learning;
calculating an information amount of each of the plurality of teacher data elements, using degrees of importance calculated respectively for a plurality of potential features included in said each teacher data element; and
selecting a teacher data element for use in the machine learning from the plurality of teacher data elements, based on information amounts of respective ones of the plurality of teacher data elements.

2. The information processing apparatus according to claim 1, wherein the selecting a teacher data element includes selecting a prescribed number of teacher data elements in descending order of information amount or teacher data elements with information amounts larger than or equal to a threshold.

3. The information processing apparatus according to claim 1, wherein
the selecting a teacher data element includes generating a first teacher data set and a second teacher data set, the first teacher data set including a first teacher data element and not including a second teacher data element with a smaller information amount than the first teacher data element, the second teacher data set including the first teacher data element and the second teacher data element, and
the process further includes obtaining a first result of the machine learning performed on the first teacher data set and a second result of the machine learning performed on the second teacher data set, and searching for a subset including a plurality of teacher data elements that produce a result of the machine learning satisfying a prescribed condition, based on the first result and the second result.

4. An information processing method comprising:
extracting, from a plurality of teacher data elements, a plurality of potential features each included in at least one of the plurality of teacher data elements;
calculating, based on a frequency of occurrence of each of the plurality of potential features in the plurality of teacher data elements, a degree of importance of said each potential feature in machine learning;
calculating an information amount of each of the plurality of teacher data elements, using degrees of importance calculated respectively for a plurality of potential features included in said each teacher data element; and
selecting a teacher data element for use in the machine learning from the plurality of teacher data elements, based on information amounts of respective ones of the plurality of teacher data elements.

5. A non-transitory computer-readable storage medium storing a computer to perform a process comprising:
extracting, from a plurality of teacher data elements, a plurality of potential features each included in at least one of the plurality of teacher data elements;
calculating, based on a frequency of occurrence of each of the plurality of potential features in the plurality of teacher data elements, a degree of importance of said each potential feature in machine learning;
calculating an information amount of each of the plurality of teacher data elements, using degrees of importance calculated respectively for a plurality of potential features included in said each teacher data element; and
selecting a teacher data element for use in the machine learning from the plurality of teacher data elements, based on information amounts of respective ones of the plurality of teacher data elements.
